(19) United States
(12) Patent Application Publication
(10) Pub. No.: US 2009/0034709 A1
(43) Pub. Date: Feb. 5, 2009

(54) System and method for look-ahead call completion

(76) Inventors: Faith McGary, Bethlehem, PA (US); Xavier Riley, Center Valley, PA (US)

Correspondence Address: Joseph Sofer;SOFER & HAROUN, L.L.P., Suite 910, 317 Madison Avenue, New York, NY, 10017, US

(21) Appl. No.: 12/220,460

(22) Filed: Jul. 24, 2008

Related U.S. Application Data
(60) Provisional application No. 60/962,170, filed on Jul. 26, 2007.
(60) Provisional application No. 61/127,484, filed on May 13, 2008.

(51) Int. Cl. H04M 3/42

(52) U.S. Cl. 379/218.01

(57) ABSTRACT

A method for providing directory assistance includes receiving a communication from a requester for a business listing and retrieving at least one first listing in response. At least one signal indicative of the status of the listing retrieved is received, and if negative, such status is conveyed to the requester. A second option is then offered to the requester, where the second option offered to the requester is for a second listing related to a same category of business as the first listing.

### RELATED APPLICATIONS

This application claims the benefit of priority from U.S. Provisional Patent Application No. 60/962,170 filed on Jul. 26, 2007 and U.S. Provisional Patent Application No. 61/127,484 filed on May 13, 2008, the entirety of which are incorporated by reference.

### FIELD OF THE INVENTION

This application relates to directory assistance processing. More particularly, this application relates to directory assistance processing with respect to communication processing and handling.

### BACKGROUND

It is often necessary to send communications to another party, and to use directory assistance services, when the desired contact information is not known. When the directory assistance system not only retrieves the desired listing, but also connects the communication to the desired party, the originator of the communication has to wait to determine whether the far end receives or answers. In many cases the requester is met with a busy signal, answering machine, disconnected line etc. . . .

In the case of directory assistance this may be particularly problematic, because the operator or IVR (Interactive Voice Response) may have already dropped the requester and connected them to the desired listing. If the contact information is invalid, the caller must then re-connect with the directory assistance system for further help. Even if the directory assistance query is eventually refunded, the entire process is inconvenient for the requester, particularly when the requester is looking for a business listing.

Some prior art systems such as those described in U.S. Patent Application No. 2005/0129208 to McGrath, employ a system whereby when a telephone caller is seeking a desired listing, the directory assistance platform sends and receive a signal regarding the status of the desired line in advance, before final connection to the listing. If the desired number is not available, then the operator may offer a second service such as simply playing the desired number to the caller (instead of call completion) or offering to perform a new search.

### OBJECTS AND SUMMARY

The present invention looks to improve on existing systems and offer a means for providing directory assistance to a requester whereby, prior to connection to the desired party, the directory assistance platform sends and receives signals such that the status of the desired party is known prior to connection.

One object of the present invention is such that if the desired party is not available or if the connection information is invalid, the directory assistance system provides options for additional alternative listings to the requester that meet their desired criteria.

Moreover, it is another object of the present invention, particularly in the case of requesters seeking business listings, to offer competing business information in response to a “not available” signal from a first requested listing.

To this end, the present invention is directed to a method for providing directory assistance that includes receiving a communication from a requester for a business listing and retrieving at least one first listing in response. At least one signal indicative of the status of the listing retrieved is received, and if negative, such status is conveyed to the requester. A second option is then offered to the requester, where the second option offered to the requester is for a second listing related to a same category of business as the first listing.

### BRIEF DESCRIPTION OF THE DRAWINGS

The present invention can be best understood through the following description and accompanying drawings, wherein:

FIG. 1 is a diagram of a directory assistance system according to one embodiment of the present invention;

FIG. 2 is a flow diagram showing a requester contacting the directory assistance system of FIG. 1, in accordance with one embodiment of the present invention;

FIG. 3 is a flow diagram showing a call flow regarding a personal contact listing request, in accordance with one embodiment of the present invention;

FIG. 4 is a flow diagram showing a call flow regarding a municipal contact listing request, in accordance with one embodiment of the present invention; and

FIG. 5 is a flow diagram showing a call flow regarding a business contact listing request, in accordance with one embodiment of the present invention.

### DETAILED DESCRIPTION

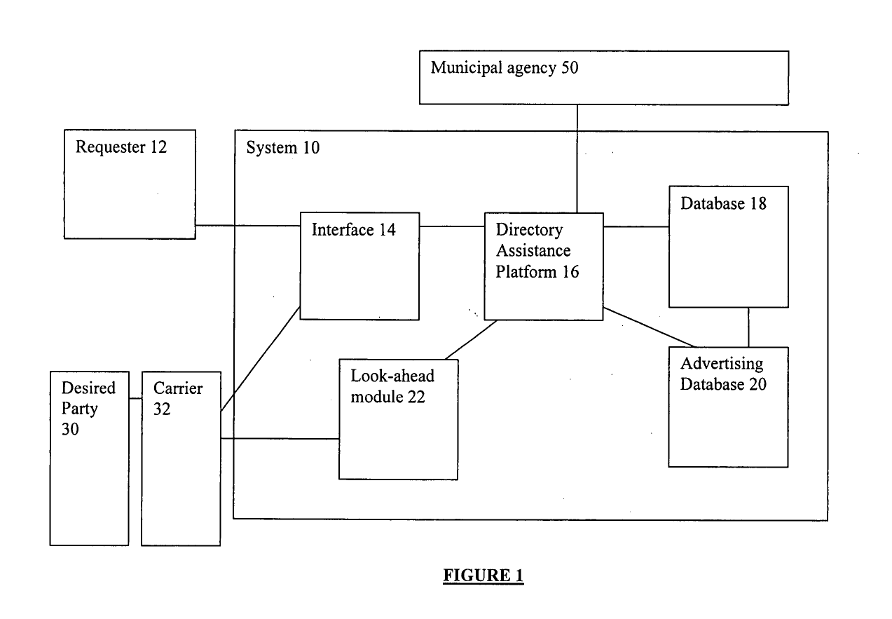

In accordance with one embodiment of the present invention, as shown in FIG. 1, a directory assistance platform 10 is shown. System 10 is configured to receive communications from a requester 12 at a communication interface 14. Once received, the communication is transferred to a directory assistance platform 16 within system 10, coupled to a listing database 18, an advertiser database 20 and call look-ahead module 22. Such a system is arranged such that requester 12 may seek a contact information for communicating with one or more desired parties 30 each supported by corresponding carrier network 32.

Requester 12 may be an individual seeking a desired party 30 using any device, including but not limited to a land line telephone, desk top computer, mobile electronic device with communication capabilities (mobile phone, PDA, mobile e-mail device, web enabled mobile device etc. . . . ). Requester 12 is capable of communicating a request for a contact information for a desired party, such as party 30, so as to initiate some form of communication with them.

Interface 14 as well as requester 12 are configured to support any form of electronic or telephonic incoming and outgoing communication formats, including but not limited to telephone, SS7 signaling, cellular telephone, SMS, e-mail, Live chat, MMS, HTML, or any other of such formats.

Once received, interface 14 transfers the request communication to directory assistance platform 16 for handling of the request, with any format translations if required. Directory assistance platform 16 may be either live operator(s), IVRs (interactive Voice Response) units or some combination of the two.

Database 18 is configured to store listing (contact) information for any number of desired parties 30. This information may be provided to system 10 by carriers 32 or directly by parties 30. The information is formatted for retrieval by directory assistance platform 16. It is contemplated that databases 18 may be maintained internally by system or may be purchased from and/or located at third party venders.

Advertiser database 20 is configured to store information regarding paid advertisers with system 10, that have paid to have their listing information pushed to requesters 12 in a preferred manner as discussed in more detail below.

Look-ahead module 22 is configured such that once a listing is retrieved from database 18 by directory assistance platform 16, module 22 may send and receive signals to carrier 32, associated with that desired party 30, to determine the status of the connection as discussed in more detail below.

It is noted that the above identified modules are only exemplary and are in no way intended to limit the scope of the invention. Additional modules may be added and extraneous modules removed as desired. It is also noted that the description of the various modules is for functional purposes only. Functions that are combined into one module or separated into sub-modules are also within the contemplation of the present invention. Furthermore, only one system 10 is shown, however, a network of such systems may be geographically positioned for request distribution handling, with certain component modules, such as databases 18, being centralized, supported by third parties etc. . . .

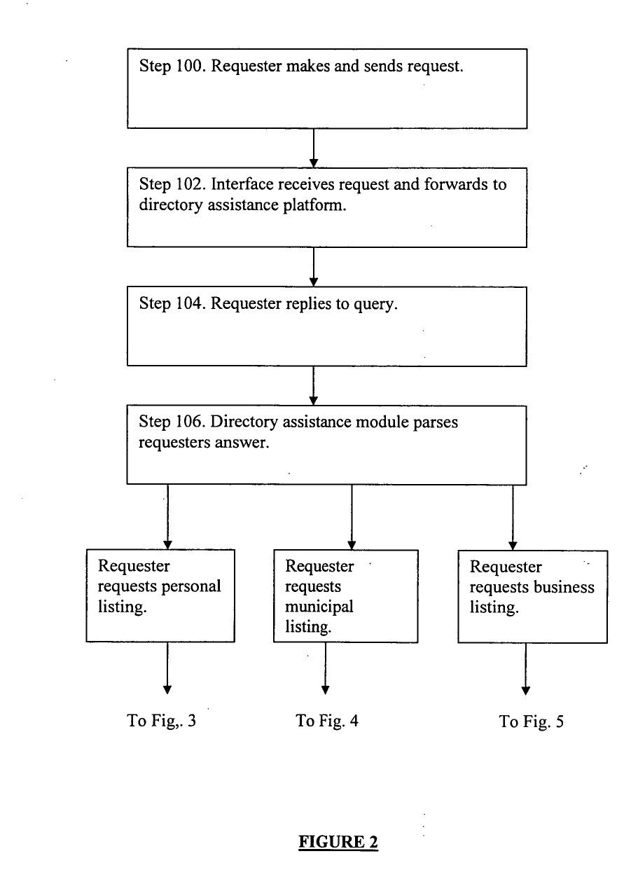

Turning now to the operation of system 10, FIG. 2 shows a flow chart for the initial phases of handling an incoming listing request communication from requester 12. At step 100, requester 12 generates a communication for handling by interface 14 of system 10, requesting a desired contact information for a party 30. Such a communication may be a telephone call to system 10, or an electronic communication (SMS, e-mail, live chat, etc. . . . ) requesting a connection information for desired party 30.

At step 102, this communication is routed to directory assistance platform 16 where requester 12 is prompted to make their substantive directory query. A typical directory query may be a response to “city and state please . . . what listing”, whereby requester 12, at step 104, states the city state and name of party 30. It is understood that such a request may take many different forms depending on the type of request (business listing, personal listing) and the format of the communication (telephone/verbal vs. electronic/text)

At step 106, directory assistance system 16 parses the content of the request and determines if it falls into one of three categories: personal, municipal, or business.

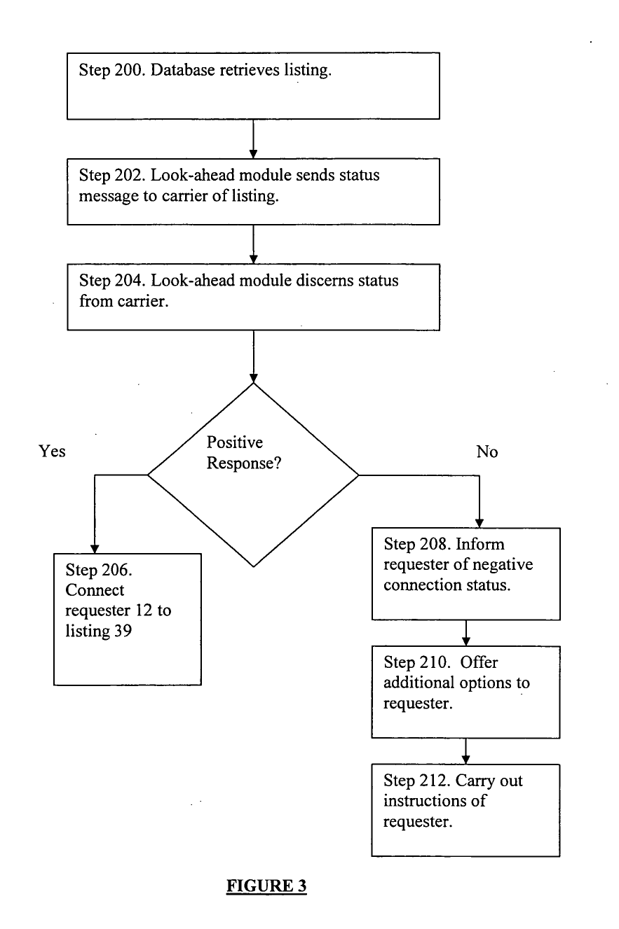

For the purposes of illustration, the following description of the call flows has been separated into FIGS. 3, 4 and 5 respectively for personal, municipal and business listings to illustrate the salient features of the invention.

Assuming the request is for a personal contact, such as a home phone number of a friend, as shown in FIG. 3, at step 200, directory assistance platform 16 dips database 18 to determine if a matching contact is found. For the purposes of illustrating the salient features of the invention, the following description is based on the situation where requester 12 receives one matching desired listing 30. However, it is understood that system 10 and directory assistance platform 16 may retrieve multiple listings, or no matching listings, such cases being resolved according to existing methods.

Once a listing 30 is selected, at step 202, prior to disclosing the contact information to requester 12 or making a communication connection between requester 12 and desired party 30, look-ahead module 22 sends a communication to the desired listing 30, through their carrier 32 to determine the status of the listing.

There are many examples of how such a communication may be processed. If desired listing 30 is a typical telephone number, the signal may be an IAM (Initial Addressing Message) using standard SS7 telephony signaling. In other instances where the desired contact is an e-mail address for example, look-ahead module 22 may simply do a veracity check (e-mail “ping”) to make sure the desired listing, pulled from database 18, is still a valid e-mail address. It is contemplated that look-ahead module 22 is capable of performing any number of similar confirmation processes, in any available communication format.

At step 204, look-ahead module 22 receives a responsive message to the initial status message or otherwise is able to discern the status (e.g. based on a lack of response), informing module 22 on the status of the listing 30. In the format of a telephone number, a positive response would be an open channel response, such as an ACM (Address Complete Message) in SS7 signaling. A negative response may be a busy signal, a disconnected signal, or even an answering machine response. Obviously, for different types of listings 30, such as e-mails, or other electronic formats, the positive and negative responses are different.

In the case of a positive response, at step 206 directory assistance platform 16 connects the requester 12 to the desired party 30, in a format that is compatible to the two parties. Such connection may be handled through communication equipment supported by system 10 or may be dropped off to be handled by the carriers of the respective parties.

In the case of a negative response, at step 208, directory assistance platform 16 informs the caller of the particular negative response received by look-ahead module 22. At step 210, system 10 then offers a series of options to requester 12 for further handling. For example, if the listing is disconnected or inactive, system 10 may offer additional directory assistance. If the listing is busy or temporarily unavailable, system 10 may offer to reconnect to the same listing 30 at a later time or in intervals until connection is made. If listing 30 is set for an answering machine, system 10 may off to allow connection anyway for leaving a message. At step 212, if an additional option is selected, that option is carried out.

In this arrangement, requester 12 is informed of the situation, prior to leaving the directory platform so that if additional options are desired they may be handled during the same directory query rather than requiring reconnection to system 10.

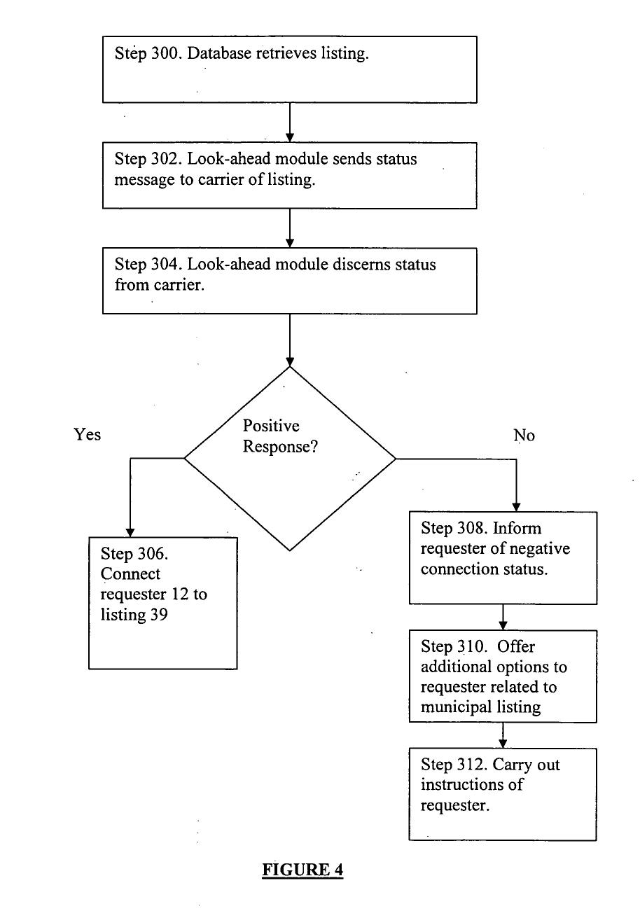

In another embodiment of the present invention, as shown in flow chart FIG. 4, if a requester 12 is seeking a municipal listing 30, such as a city/state agency, then the call processing proceeds through steps 300-308, similar to steps 200-208 as described above. The contact information is retrieved from database 18 and, if look-ahead module 22 finds a positive response, then the call is connected at step 306. If the look-ahead response is negative then the condition is conveyed to requester 12 at step 308.

However, at step 310, because listing 30 is a municipal listing, the options presented to requester 12 are dependent not only on the connection condition of listing 30, but also the type/category of the listing itself. For example, in many instances, requesters 12 seeking municipal contact information are under some urgent condition. It is contemplated that system 10 may be coupled to one more municipal alert systems 50 so that in the case of certain emergencies, when a desired listing is not available (received a negative response at look-ahead module 22 at step 308), at step 310, the secondary service offered to requester 12 may be directly related to the context of the request itself.

In one example, in a heavy snow condition, requester 12 may wish to contact a local authority to determine snow emergency routes. However, it is likely that many other callers to such an agency would be flooding in causing a busy signal. In accordance with one embodiment of the present invention, system 10, coupled to a municipal agency 50 may be able to recognize the call context from the query at steps 104, 106 and 300, such as an agency in charge of snow routes. Thus, as step 310, the system may, among its offerings to requester 12, offer the desired snow emergency information directly that was obtained earlier from municipal alert system 50.

Such a system may be employed for such conditions including but not limited to amber alerts, town hall meetings, civil defense issues, nuclear emergencies, community emergencies, community events, traffic issues, public transportation alerts etc. . . .

In one embodiment of the present invention, upon monitoring of many communications from requesters 12 related to one event, system 10 may even establish a contact with a new municipal agency 50, even if such a connection did not previously exist, to assist in the situation.

After directory assistance platform 16 offers the desired secondary services in view of a negative look-ahead response, at step 312, requester 12 may select a desired option.

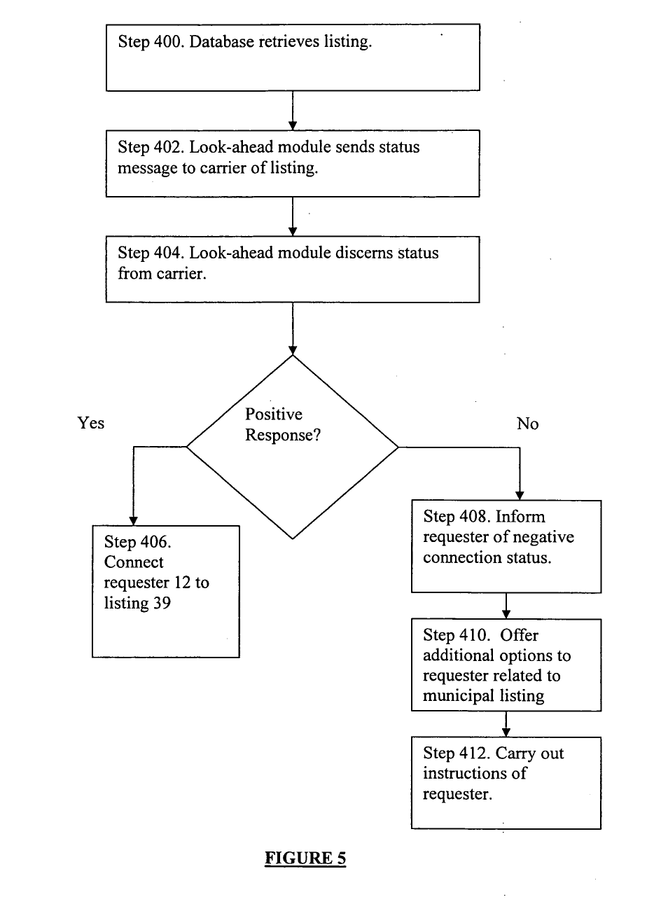

In another embodiment of the present invention, as shown in flow chart FIG. 5, if a requester 12 is seeking a business number, such as a local hardware store, then the call processing proceeds through steps 400-408, similar to steps 200-208 as described above. The contact information is retrieved from database 18 and, if look-ahead module 22 finds a positive response, then the call is connected at step 406. If the look-ahead response is negative then the condition is conveyed to requester 12 at step 408.

However, at step 410, the options presented to requester 12 are dependent not only on the condition of the listing 30, but also the category of the listing itself. For example, in many instances, requesters 12 seeking business contact information want swift resolution of the call, and are not necessary desiring a particular number as much as desiring a particular type of service.

When requester 12 requests a particular hardware store, even by name, it may be based simply on knowledge of the name (trademark). However, if listing 30 for that store is unavailable or not open, requester 12 may be equally happy with any hardware store in the vicinity that can meet their needs. This is even more true when the initial request for a listing 30 is not a specific request but a category type request where requester 12 does not even specify a specific provider by name, but only requests a listing 30 from a category.

It is contemplated that system 10 is coupled to an advertising database 20 that is configured to store listings, or information (tags, rankings etc. . . . ) about listings in database 18, so that if a busy condition or other negative response is received by look-ahead module 22 at step 404, then a listing from advertiser database 20 may be pushed to the caller instead at step 410.

For example, in the event a user makes a business request for a specific listings such as “ABC hardware” then, in the event of a busy signal from ABC hardware received at look ahead module 22 in step 408, directory assistance platform may offer a second option at step 410 such as “XYZ hardware,” which is paid advertiser with system 10.

The organization and frequency with which advertisers are pushed to requesters 12 may be based on any combination of money paid, randomness, alphabetical cycling, algorithms for determining the likelihood of desirability to requesters, requester 12 profiles stored with system 10 etc. . . .

Furthermore, it is contemplated that advertiser database 20 may also be used in a dual role. For example, if requester 12 makes a category type business request, even the initial response at step 404 from directory assistance platform 16 may be taken from a combination of database 18 and advertising database 20 such that not only does the retrieved listing match the request (using SIC codes (Standard Industry Codes) but the listing 30 may also be a paid advertiser. Thereafter, if for any reason connection to that paid advertiser receives a negative response at look-ahead module 22 in step 408, then during the same call, advertiser database 20 may again be used to offer yet another paid advertiser listing 30 from database 18 to requester 12 at step 410 until a positive response to look ahead module 22 is received at step 406.

Such a configuration allows for requesters 12 making either specific or category type business listing requests to receive a valid connection on the first connection with system 10, even if an initial desired listing has an invalid contact information. Moreover, system 10 may benefit from receiving advertiser revenue from this same situation by analyzing the first request and providing a second desirable listing to requester 12 that does have a valid and working connection.

In another embodiment of the present invention, when requester 12 requests a business listing as noted in step 106, upon retrieving listing 30 at step 400, two or more listings are retrieved in the same category and vicinity of the requested listing, regardless of an initial specific or category type request. In such an arrangement it is contemplated that, if at step 404 a negative response is received at look-ahead module 22, then a second (or third . . . ) listing 30 is available immediately without additional search time to ensure that prompt response times are achieved.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A method for providing directory assistance, said method comprising the steps of:
receiving a communication from a requester for a business listing;
retrieving at least one first listing in response to said request;
receiving at least one signal indicative of the status of said listing retrieved in response to said request;
if said signal indicative of the status of said listing is negative, conveying said status to said requester;
offering a second option to said requester, wherein said second option offered to said requester is for a second listing related to a same category of business as said first listing.

2. The method as claimed in claim 1, wherein said communication from a requester for a business listing is either one of a category type request or a specific listing request.

3. The method as claimed in claim 1, wherein said second option, offered to said requester is for a second listing related to a same category of business as said first listing, is a paid advertiser.

4. The method as claimed in claim 1, wherein said signal, indicative of the status of said listing, is negative if conditions are such that requester can not connect with said first listing.

5. The method as claimed in claim 1, further comprising the step of retrieving a plurality of listings in response to said request, including said first listing and at least one of said second listings, such that if said second option is offered to said requester, said second listing for said offering is already retrieved without further searching.

6. A system for providing directory assistance, said system comprising:
an interface for receiving a communication from a requester for a business listing;
a directory assistance platform for retrieving at least one listing from a database in response to said request;
a look-ahead module for receiving at least one signal indicative of the status of said listing retrieved in response to said request, wherein if said signal is negative, conveying said status to said requester and offering a second option to said requester, with the second option being for a second listing related to a same category of business as said first listing.

7. The system as claimed in claim 6, further comprising an advertising module for storing information regarding business listings, such that said second listing, provided to said requester is based on information contained in said advertising module.

8. A method for providing directory assistance, said method comprising the steps of:
receiving a communication from a requester for a municipal listing;
retrieving at least one listing in response to said request;
receiving at least one signal indicative of the status of said listing retrieved in response to said request;
if said signal indicative of the status of said listing is negative, conveying said status to said requester;
offering a second option to said requester, wherein said second option offered to said requester is for information that is otherwise provided by said requested municipal listing.

9. The method as claimed in claim 8, wherein said information that is otherwise provided by said requested municipal listing is received from said municipal listing.

10. The method as claimed in claim 1, wherein said information that is otherwise provided by said requested municipal listing is selected from the group consisting of: amber alerts, town hall meetings, civil defense issues, nuclear emergencies, community emergencies, community events, traffic issues and public transportation alerts.
